(19) United States
(12) Patent Application Publication
(10) Pub. No.: US 2026/0342718 A1
(43) Pub. Date: Oct. 29, 2026

(54) PATH COMBINATION SELECTION FOR A MULTIPATH SESSION

(71) Applicant: Hewlett Packard Enterprise Development LP, Spring, TX (US)

(72) Inventors: Gopal Gupta, Bangalore (IN); Isaac Theogaraj, Bangalore (IN)

(21) Appl. No.: 19/252,389

(22) Filed: Jun. 27, 2025

(30) Foreign Application Priority Data
Apr. 29, 2025 (IN) 202541041249

(51) Int. Cl. H04L 45/24; H04L 43/08

(52) U.S. Cl. CPC H04L 45/24; H04L 43/08

(57) ABSTRACT

In some examples, a system receives metrics of a plurality of network paths connected to a computing environment. The system determines performances of respective path combinations of the plurality of network paths based on the metrics. The path combinations include a first path combination including a first subset of network paths of the plurality of network paths, and second path combination including a different second subset of network paths of the plurality of network paths. The system selects, based on the determined performances, a path combination from the path combinations for a multipath session between a client device and the computing environment.

### BACKGROUND

Computing environments such as data centers, cloud environments, or other types of computing environments can provide services for client devices. The client devices are able to access the computing environments over a network.

### BRIEF DESCRIPTION OF THE DRAWINGS

Some implementations of the present disclosure are described with respect to the following figures.

FIG. 1 is a block diagram of an arrangement including a client device, an intermediate network device, and a computing environment, according to some examples.

FIG. 2 is a flow diagram of a path combination selection process according to some examples of the present disclosure.

FIG. 3 is a block diagram of a storage medium storing machine-readable instructions according to some examples.

FIG. 4 is a block diagram of a system according to some examples.

FIG. 5 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Client devices can communicate with a computing environment through network devices of a network arrangement. Examples of network devices include switches, wireless access points, gateways, concentrators, or other network devices. A network device may have multiple network paths to the computing environment. In some examples, the network device may implement the Multipath Transmission Control Protocol (MPTCP), which is described in Request for Comments (RFC) 8684, entitled “TCP Extensions for Multipath Operation with Multiple Addresses,” dated March 2020. MPTCP allows a TCP connection between a client device and the computing environment (where the TCP connection passes through the network device implementing MPTCP) to make use of the multiple network paths between the network device and the computing environment. These multiple network paths are referred to as “uplink paths” over which bidirectional communications between the client device and the computing environment can occur.

An MPTCP scheduler in the network device can establish a multipath connection (an MPTCP session) that contains multiple subflows over respective uplink paths. Throughput can be improved by concurrently transferring data of the MPTCP session over the uplink paths. The MPTCP scheduler can dynamically add or remove subflows in the multipath connection. Also, the MPTCP scheduler can achieve redundancy by transferring duplicate packets over multiple uplink paths. The MPTCP scheduler can also reduce latency of the MPTCP session by selecting lower latency uplink paths to transfer packets.

The performance of an MPTCP session can suffer if the uplink paths have large differences in performance or some uplink paths are faulty or overloaded. For example, after an MPTCP session is established that makes use of multiple uplink paths, a given uplink path may suddenly deteriorate in performance. Although the MPTCP scheduler may react to the sudden deterioration of the given uplink path by routing data away from the given uplink path, the reaction time of the MPTCP scheduler may be slow and thus overall performance of the MPTCP session may suffer.

In accordance with some implementations of the present disclosure, metrics of a plurality of network paths (e.g., uplink paths) connected to a computing environment can be collected for use in determining performances of respective path combinations of the plurality of network paths. Each path combination includes a respective different subset of network paths of the plurality of network paths. Based on the determined performances, a path combination is selected from the path combinations for a multipath session between a client device and the computing environment. The selected path combination can be according to a policy for an entity associated with the multipath session, where the entity can be a user of the client device, a group of users that the user is part of, an application program running on the client device, a provider of the computing environment, or any other entity. The policy can include a preference for reduced costs in terms of monetary cost or resource usage cost, improved performance (e.g., reduced latency, increased throughput, reduced error rate, etc.), or any other preference.

In some examples, the performances of the respective path combinations can be produced by a machine learning model based on the metrics. For example, the performances of the respective path combinations can be indicated based on a ranking of the respective path combinations by the machine learning model using the metrics as input to the machine learning model. Using the metrics, the machine learning model can predict whether the performance (e.g., cost performance or operational performance) of a path combination is degraded or will likely degrade. This prediction allows for a quicker response to changing conditions of the plurality of network paths. For example, if the prediction determines that a currently selected path combination for the multipath session is likely to no longer satisfy a given policy, then a different path combination can be selected that will satisfy the given policy. The ability to select a path combination that will more likely satisfy a policy associated with a multipath session improves computer functionality of a client device or the relevant technology of network communications.

In addition to increasing the likelihood that the selected path combination would satisfy the policy associated with a multipath session, techniques or mechanisms according to some examples of the present disclosure can also address the slow start feature of TCP sessions, including MPTCP sessions. In a TCP session, the slow start feature is provided for congestion control to avoid sending more data than the network is capable of transferring. Using a selected path combination for an MPTCP session in accordance with some examples of the present disclosure can improve the slow start performance of the MPTCP session by more quickly allowing a congestion window to grow and the transmission rate to increase.

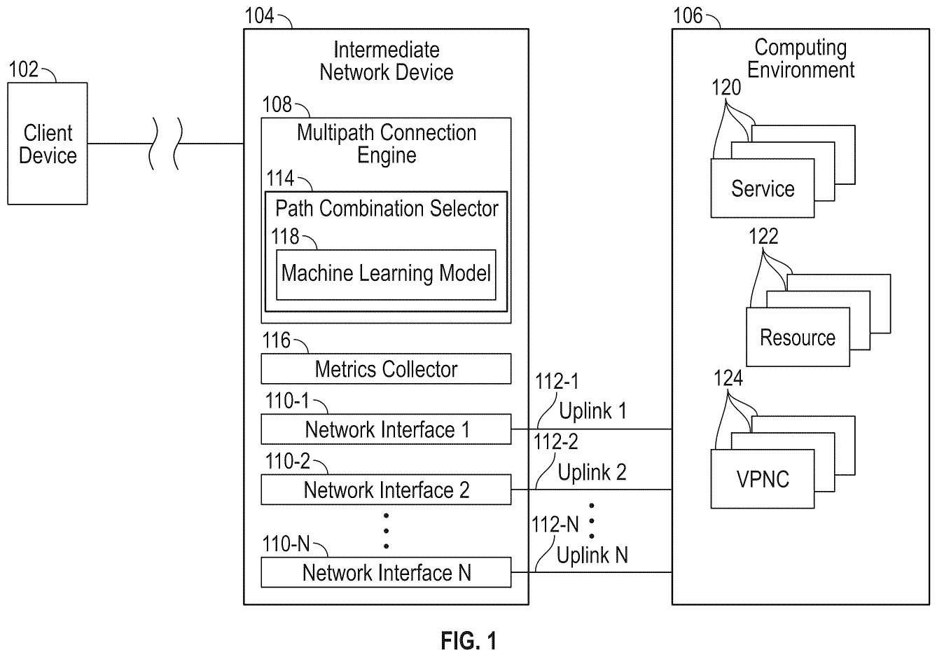

FIG. 1 is a block diagram of an example arrangement that includes a client device 102, an intermediate network device 104, and a computing environment 106. The computing environment 106 can be a data center, a cloud environment, or another type of computing environment. In further examples, multiple client devices can be connected by the intermediate network device 104 to the computing environment 106. Moreover, there may be multiple intermediate network devices between client devices and the computing environment 106.

An “intermediate” network device is a network device that forwards data between other devices, such as the client device 102 and a device of the computing environment 106. Examples of intermediate network devices can include any or some combination of a branch gateway or any other type of gateway, a router, a switch, or another type of network device. A branch gateway is a type of edge router that can be coupled over network paths to a computing environment. A branch gateway can be part of a software defined wide area network (SD-WAN) for managing which network path(s) to use for data communications between a client device and the computing environment 106.

In accordance with some examples of the present disclosure, the intermediate network device 104 includes a multipath connection engine 108 that can establish a multipath session for a traffic flow between the client device 102 (or another client device) and the computing environment 106. An example of a traffic flow includes a TCP flow in which data packets exchanged between the client device 102 and computing environment 106 occurs over a TCP connection established according to the TCP protocol. If TCP is used, the multipath session is an MPTCP session in which the data packets of the TCP flow are transferred through subflows over respective network paths of the MPTCP session.

In other examples, a multipath session can be according to a different protocol, including any of the following: the Multipath QUICK User Datagram Protocol (UDP) Internet Connections (QUIC) protocol; the Stream Control Transmission Protocol with Concurrent Multipath Transfer (SCTP with CMT) protocol; the Multipath Datagram Congestion Control Protocol (MP-DCCP); or other protocols, whether standardized, open-source, or proprietary.

Although FIG. 1 shows an example with the multipath connection engine 108 is part of the intermediate network device 104, in a different example, a client device, such as the client device 102, can include a multipath connection engine to establish a multipath session (e.g., an MPTCP session) between the client device and the computing environment 106. Techniques or mechanisms according to some examples of the present disclosure can be used with such as multipath connection engine in a client device.

In some examples, the multipath connection engine 108 can establish multipath sessions for certain types of data flows. For example, multipath sessions can be established for data flows of specific types of application programs (e.g., types of application programs that are deemed to be more important or critical than other types of application programs). In such examples, the multipath connection engine 108 does not establish multipath sessions for the less important types of application programs. In further examples, the multipath connection engine 108 can decide to establish a multipath session for a data flow if the multipath connection engine 108 determines that a current performance of the data flow is suffering (e.g., not meeting a specified threshold). In other examples, the multipath connection engine 108 can decide to establish a multipath session for a data flow based on historical trends, routing rules, and so forth. More generally, the multipath connection engine 108 can selectively establish multipath sessions for selected data flows and not establish multipath sessions for other data flows.

The intermediate network device 104 includes multiple network interfaces 110-1, 110-2, . . . , 110-N (where N≥3). A “network interface” can include a transceiver to transmit and receive signals and one or more protocol layers that govern how data is communicated using respective one or more communication protocols. For example, the network interface 110-1 may support communications according to the Multiprotocol Label Switching (MPLS) protocol, which forwards data based on labels rather than network addresses. The labels identify network paths rather than endpoints. The network interface 110-2 may support communications over a cellular network such as a fourth generation (4G), fifth generation (5G), or beyond mobile communications network. The network interface 110-N may support communications according to the Ethernet protocol over a wired network. Although specific examples of different types of communication technologies are listed above, it is noted that the network interfaces 110-1 to 110-N can support additional or alternative communication technologies in further examples.

The network interfaces 110-1, 110-2, . . . , 110-N are connected over respective network paths, depicted as uplink paths 112-1, 112-2, . . . , 112-N, to the computing environment 106. A multipath session established for a traffic flow with the computing environment 106 can include a path combination made up of two or more of the uplink paths 112-1 to 112-N. For example, a first path combination can include a first subset of the uplink paths 112-1 to 112-N, a second path combination can include a different subset of the uplink paths 112-1 to 112-N, and so forth. More generally, if there are N uplink paths, then a path combination can include 2 to N−1 uplink paths.

The multipath connection engine 108 can be implemented using one or more hardware processing circuits, which can include any or some combination of a microprocessor, a core of a multi-core microprocessor, a microcontroller, a programmable integrated circuit, a programmable gate array, or another hardware processing circuit. Alternatively, the multipath connection engine 108 can be implemented using a combination of one or more hardware processing circuits and machine-readable instructions (software and/or firmware) executable on the one or more hardware processing circuits.

The multipath connection engine 108 includes a path combination selector 114 according to some examples of the present disclosure. The path combination selector 114 can be implemented using a portion of the hardware processing circuitry of the multipath connection engine 108, or with machine-readable instructions executed by the hardware processing circuitry of the multipath connection engine 108.

For each multipath session, the path combination selector 114 can select a respective path combination that includes a subset of the uplink paths 112-1 to 112-N. The path combination selector 114 can obtain metrics (e.g., cost metrics, operational performance metrics, etc.) from a metrics collector 116 in the intermediate network device 104 (or outside the intermediate network device 104). The metrics collector 116 can be implemented using one or more hardware processing circuits or a combination of one or more hardware processing circuits and machine-readable instructions.

Cost metrics can include any or some combination of the following: a metric representing a monetary cost associated with utilizing an uplink path, or a metric representing a cost in terms of resource utilization (such as utilizations of processing, memory, and/or communication resources).

An operational performance metric indicates how well an uplink path is operating. Examples of operational performance metrics can include any or some combination of the following: a latency (delay in data communications) of the uplink path, a throughput (e.g., bits transferred per time interval) of the uplink path, an error rate of the uplink path, a TCP congestion window (that is used to restrict how much data can be in transit within a time interval), bandwidth availability (how much of the bandwidth is available over the uplink path), a jitter of the uplink path, a round-trip time (RTT) of data over the uplink path, a delay distribution (that represents a range of delays experienced by data packets), a packet reordering metric (that indicates how much reordering of out-of-sequence data packets are received at a recipient), or any other operational performance metric.

The operational performance metrics can be obtained as part of health checks initiated by the metrics collector 116. The health checks can be performed on a repeated basis (e.g., once every health check interval) or in response to other events (e.g., an error indication, a fault indication, an overload indication, etc.).

Based on the metrics from the metrics collector 116, performances (e.g., cost performances, operational performances, etc.) of respective path combinations (which include different subsets of the uplink paths 112-1 to 112-N) are determined by the path combination selector 114. Based on a policy, the path combination selector 114 can select a path combination from the multiple path combinations for the multipath session of the client device 102. For example, if the policy includes a preference for reduced cost, then the path combination selector 114 can select a path combination with a lower cost. As another example, if the policy includes a preference for an elevated operational performance, then the path combination selector 114 can select a path combination with a higher operational performance. Note that a policy can include preferences based on multiple factors, including a combination of lower cost and elevated operational performance, for example.

In some examples of the present disclosure, the metrics from the metrics collector 116 can be input into a machine learning model 118, which can be part of or separate from the path combination selector 114. Performances of respective path combinations are produced by the machine learning model 118 based on the metrics. The performances can include predicted performances that provide an expected performance of a respective path combination in a future time interval based on the metrics. For example, given current values of the metrics from the metrics collector 116, the machine learning model 118 may predict a degraded performance (e.g., in terms of cost and/or operational performance) of a given path combination in the future time interval, even though the given path combination is not currently experiencing the degraded performance.

In some examples, the machine learning model 118 can indicate the performances of the respective path combinations by ranking the respective path combinations using the metrics as input to the machine learning model 118. For example, the machine learning model 118 may output rank indicators for the respective path combinations. The rank indicators can include numerical (or other types of) values specifying relative ranks of the respective path combinations. More generally, the machine learning model 118 can output performance indicators representing the performances of the respective path combinations. A performance indicator can include a value representing a respective performance (e.g., cost and/or operational performance) of a path combination. Alternatively, a performance indicator can include a rank indicator specifying a rank of a given path combination relative to another path combination.

The metrics collector 116 can receive metrics from various sources, including hardware sensors and/or software sensors, that measure properties of each of the uplink paths 112-1 to 112-N. Other sources can include websites, data repositories, and so forth.

Since the metrics are continually provided by the metrics collector 116 to the machine learning model 118, the machine learning model 118 can dynamically indicate different performances of the respective path combinations as the values of the metrics change. Also, the machine learning model 118 can be continually trained so that the machine learning model 118 can refine its predictions of the performances of the respective path combinations.

Examples of the machine learning model 118 can include any or some combination of the following: a Multi-Label Decision Tree (ML-DT) model, an Autoregressive Integrated Moving Average (ARIMA) model, a Long Short-Term Memory (LSTM) model, a Prophet model, or another type of machine learning model.

In some examples, the metrics collector 116 can collect metrics in individual test sessions (e.g., individual test TCP sessions) over respective uplink paths. For example, the metrics collector 116 can establish a first individual test TCP session over the uplink paths 112-1 to obtain metrics for the uplink path 112-1, an individual test TCP session over the uplink paths 112-2 to obtain metrics for the uplink path 112-2, and so forth.

The metrics collected individually for the uplink paths can be aggregated to determine a performance of a path combination. For example, if a first path combination includes the uplink paths 112-1 and 112-N, then the metrics collected individually for the uplink paths 112-1 and 112-N can be aggregated (e.g., summed, averaged, etc.) to determine the performance of the first path combination. As another example, if a second path combination includes uplink paths 112-2 and 112-N, then the metrics collected individually for the uplink graphs 112-2 and 112-N can be aggregated to determine the performance of the second path combination.

In other examples, multipath test sessions (e.g., MPTCP test sessions) can be established by the metrics collector 116 over respective subsets of the uplink paths for the purpose of collecting metrics in the multipath test sessions. For example, the metrics collector 116 can establish a first MPTCP test session that utilizes a first path combination including the uplink paths 112-1 and 112-2. The metrics collector can collect metrics for the first path combination in the first MPTCP test session. The metrics collector 116 can establish a second MPTCP test session that utilizes a second path combination including uplink paths 112-1 and 112-N. The metrics collector can collect metrics for the second path combination in the second MPTCP test session.

An example type of test communication that can be performed in a test session (either an individual test session or a multipath test session) includes performing a download of data from the computing environment 106 to the client device 102. An example of a data download includes a File Transfer Protocol (FTP) download of one or more files from the computing environment 106. Other types of data downloads can be performed in other examples. Another example type of test communication that can be performed can include performing bidirectional data communication, such as in an audio exchange session, a videoconferencing session, a chat session, and so forth, between client device 102 and the computing environment 106. A further example type of test communication can include unidirectional streaming of audio and/or video data. More generally, a test communication includes a transfer of test data packets between a client device and a computing environment.

The computing environment 106 includes various services 120 and resources 122 that are accessible to client devices, including the client device 102. Examples of the resources 122 can include processing resources (e.g., server computers, hardware processors, graphics processing units (GPUs), etc.), memory or storage resources, communication resources, or other types of resources. Examples of the services 120 can include services offered by application programs, services of containers or virtual machines (VMs), and so forth.

In some examples, the computing environment 106 can include virtual private network concentrators (VPNCs) 124. The uplink paths 112-1 to 112-N can be connected to one or more of the VPNCs 124. A VPNC refers to a network device that manages multiple VPN connections from client devices to the computing environment 106. A VPN includes a secure connection between a client device and the computing environment 106. Although reference is made to using VPNs and VPNCs according to some examples, it is noted that in other examples, other types of connections can be established between client devices and the computing environment 106. In such other examples, the VPNCs 124 may be omitted.

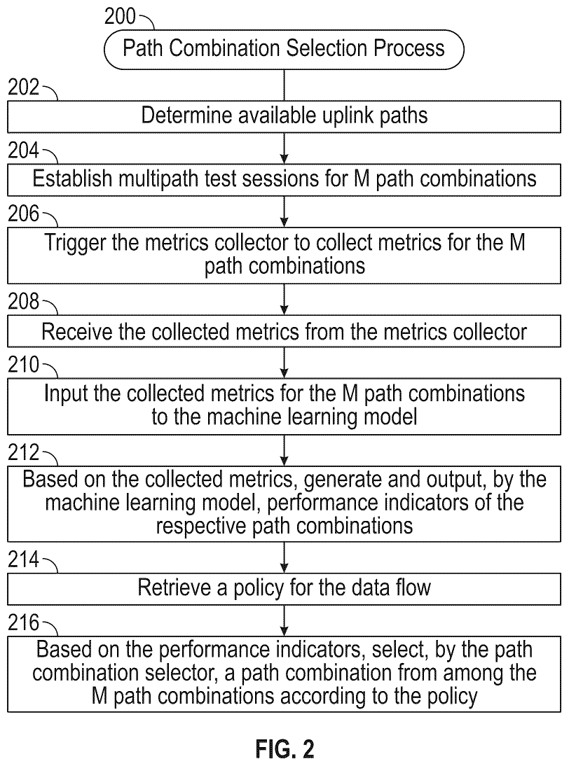

The following discussion refers to both FIG. 1 and FIG. 2. FIG. 2 is a flow diagram of a path combination selection process 200 performed by the multipath connection engine 108, in accordance with some examples of the present disclosure. The path combination selection is for a particular data flow (e.g., TCP flow) between the client device 102 (or another client device) and the computing environment 106.

The path combination selector 114 in the multipath connection engine 108 determines (at 202) available uplink paths (e.g., 112-1 to 112-N) to the computing environment 106. The determination of the available uplink paths can include accessing configuration information of the intermediate network device 104 to identify which uplink paths are available for use for data transfers of the client device 102.

It is assumed that there are M path combinations that includes respective subsets of the N available uplink paths, where M≥3. For example, if there are 3 available uplink paths 112-1, 112-2, and 112-3, then the M=3 path combinations include path combination {112-1, 112-2}, {112-1, 112-3}, and {112-1, 112-3}. If there are 4 available uplink paths 112-1, 112-2, 112-3, and 112-4, and assuming each path combination includes 3 uplink paths, then the M=4 path combinations include path combination {112-1, 112-2, 112-3}, {112-1, 112-2, 112-4}, {112-1, 112-3, 112-4}, and {112-2, 112-3, 112-4}. Note that in the latter example more than 4 path combinations exist if a patch combination can also include just two uplink paths.

In some examples, the multipath connection engine 108 establishes (at 204) multipath test sessions for the M path combinations. More specifically, the multipath connection engine 108 establishes a first multipath test session for a first path combination, a second multipath test session for a second path combination, and so forth.

For example, an Internet Protocol (IP) table rule (or more generally, a flow path forwarding rule) can be created by the multipath connection engine 108 that selects the uplink paths of the path combination of each multipath test session (e.g., MPTCP test session) to use for collecting metrics. The IP table rule includes an entry that specifies routes (uplink paths) to use for test data packets transferred in the multipath test session. A test data packet is a data packet that has a specified source IP address (e.g., a health check source IP address having a specific value) indicating that the data packet is for testing a multipath test session. The test data packet also includes a specified destination IP address (e.g., a health check destination IP address having a specific value) that identifies a destination in the computing environment 106 to be used for testing the multipath test session. The IP table rule indicates that a data packet from the health check source IP address to the health check destination IP address is to use one of the routes specified in the IP table rule. Different IP table rules are created for different multipath test sessions.

The path combination selector 114 triggers (at 206) the metrics collector 116 to collect metrics for the M path combinations. For example, the path combination selector 114 can send a request to the metrics collector 116 to start collecting metrics for the M path combinations.

The path combination selector 114 receives (at 208) the collected metrics from the metrics collector 116, and inputs (at 210) the collected metrics for the M path combinations to the machine learning model 118. Based on the collected metrics, the machine learning model 118 generates and outputs (at 212) performance indicators of the respective path combinations.

The path combination selector 114 retrieves (at 214) a policy for the data flow. Based on the performance indicators, the path combination selector 114 selects (at 216) a path combination from among the M path combinations according to the policy. The selected path combination is used by the intermediate network device 104 data transfers of the data flow.

Although FIG. 2 refers to an example in which multipath test sessions for the M path combinations are established for the purpose of collecting metrics, in other examples, the metrics collector 116 can collect metrics in individual test sessions over respective uplink paths, and the collected metrics in individual test sessions are input into the machine learning model 118 for generating the performance indicators of the respective path combinations.

In other examples, individual instances of the machine learning model 118 can be applied to metrics collected for the individual test sessions. The outputs of selected individual instances of the machine learning model 118 can then be combined for each path combination to provide a performance indicator that can be used for path combination selection. For example, if a given path combination includes uplink paths 112-1 and 112-2, then a first individual instance of the machine learning model 118 can be applied to metrics collected for a first individual test session over the uplink path 112-1, and a second individual instance of the machine learning model 118 can be applied to metrics collected for a second individual test session over the uplink path 112-2. Then the outputs of the first individual instance of the machine learning model 118 and the second individual instance of the machine learning model 118 can be mathematically combined (e.g., summed, averaged, etc.) to produce a performance indicator for the given path combination.

In alternative examples, the path combination selection process 200 may be performed by a multipath connection engine (similar to 108) in a client device, such as the client device 102.

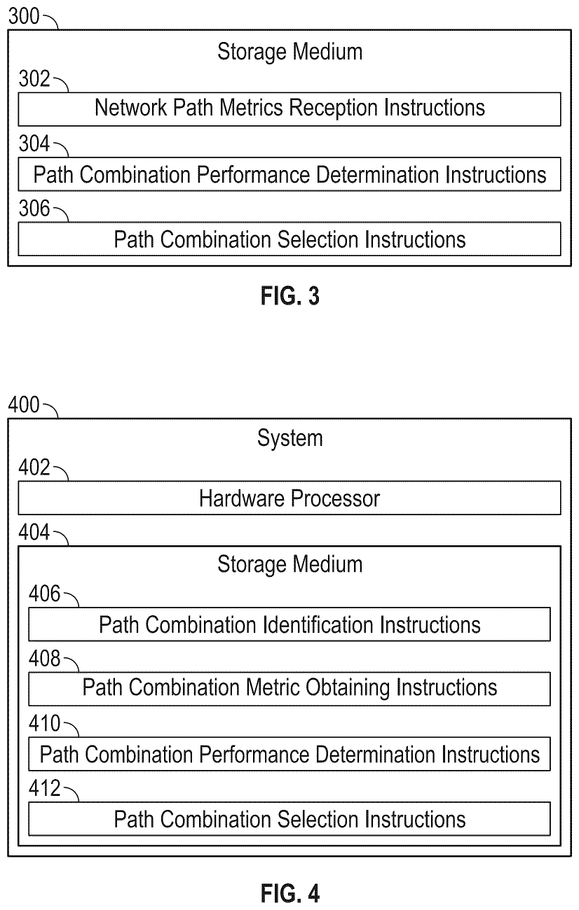

FIG. 3 is a block diagram of a non-transitory machine-readable or computer-readable storage medium 300 storing machine-readable instructions that upon execution cause a system to perform various tasks according to some examples of the present disclosure. The system may be the intermediate network device 104 or the client device 102 of FIG. 1, for example.

The machine-readable instructions include network path metrics reception instructions 302 to receive metrics of a plurality of network paths connected to a computing environment. The network paths can be the uplink paths 112-1 to 112-N of FIG. 1. If the system is the intermediate network device 104, then the network paths are between the intermediate network device 104 and the computing environment. If the system is the client device 102, then the network paths are between the client device 102 and the computing environment.

The machine-readable instructions include path combination performance determination instructions 304 to determine performances of respective path combinations of the plurality of network paths based on the metrics. The path combinations include a first path combination including a first subset of network paths of the plurality of network paths, and second path combination including a different second subset of network paths of the plurality of network paths. The path combinations may further include one or more other subsets of network paths.

The machine-readable instructions include path combination selection instructions 306 to select, based on the determined performances, a path combination from the path combinations for a multipath session between a client device and the computing environment. In some examples, the selection can be based on a policy for an entity associated with the multipath session, where the entity can be a user of the client device, a group of users that the user is part of, an application program running on the client device, a provider of the computing environment, or any other entity.

In some examples, the system can establish a plurality of multipath test sessions (e.g., MPTCP test sessions) between the client device and the computing environment. The plurality of multipath test sessions use different subsets of network paths of the plurality of network paths. The system can receive the metrics in the plurality of multipath test sessions.

In some examples, in a given multipath test session of the plurality of multipath test sessions, the system can initiate a data download (e.g., an FTP file transfer, data streaming, or another type of data download) from the computing environment to test a respective subset of network paths used by the given multipath test session. The system can record the metrics for the respective subset of network paths responsive to the data download in the given multipath test session.

In some examples, in a given multipath test session of the plurality of multipath test sessions, the system can initiate bidirectional data communications between the client device and the computing environment to test a respective subset of network paths used by the given multipath test session. The system can record the metrics for the respective subset of network paths responsive to the bidirectional data communications in the given multipath test session.

In some examples, the system can establish individual test sessions between the client device and the computing environment using respective individual network paths of the plurality of network paths. The system can receive the metrics in the individual test sessions.

In some examples, the system can rank the respective path combinations based on the determined performances of the respective path combinations. The system can select the path combination from the path combinations for the multipath session based on the ranking.

In some examples, the system can determine the performances of the respective path combinations using a machine learning model based on the metrics.

In some examples, the system can apply the machine learning model to the metrics for the first subset of network paths collectively to determine a performance of the first path combination.

In some examples, the system can apply an individual instance of the machine learning model to the metrics individually for each respective network path of the first subset of network paths to determine individual performances of the network paths in the first subset of network paths. The system can combine the individual performances of the network paths in the first subset of network paths to determine a performance of the first path combination.

In some examples, the metrics of the plurality of network paths are received for a first time interval. The system can receive further metrics of the plurality of network paths for a second time interval after the first time interval, and determine updated performances of at least some of the path combinations based on the further metrics. The system can update, based on the updated performances, a selection of a path combination from the path combinations for the multipath session.

FIG. 4 is a block diagram of a system 400 according to some examples of the present disclosure. An example of the system 400 may be the intermediate network device 104 or the client device 102 of FIG. 1.

The system 400 includes a hardware processor 402 (or multiple hardware processors). A hardware processor can include a microprocessor, a core of a multi-core microprocessor, a microcontroller, a programmable integrated circuit, a programmable gate array, or another hardware processing circuit.

The system includes a storage medium 404 storing machine-readable instructions executable on the hardware processor 402 to perform various tasks. Machine-readable instructions executable on a hardware processor can refer to the instructions executable on a single hardware processor or the instructions executable on multiple hardware processors.

The machine-readable instructions in the storage medium 404 include path combination identification instructions 406 to identify multiple path combinations of a plurality of network paths connected to a computing environment. The multiple path combinations include a first path combination including a first subset of network paths of the plurality of network paths, and second path combination including a different second subset of network paths of the plurality of network paths.

The machine-readable instructions in the storage medium 404 include path combination metric obtaining instructions 408 to obtain metrics for the multiple path combinations. The metrics may be obtained in multipath test sessions or individual test sessions.

The machine-readable instructions in the storage medium 404 include path combination performance determination instructions 410 to determine performances of respective path combinations of the multiple path combinations based on the metrics. The performances may be determined using a machine learning model, for example.

The machine-readable instructions in the storage medium 404 include path combination selection instructions 412 to select, based on the determined performances, a path combination from the multiple path combinations for a multipath session between a client device and the computing environment.

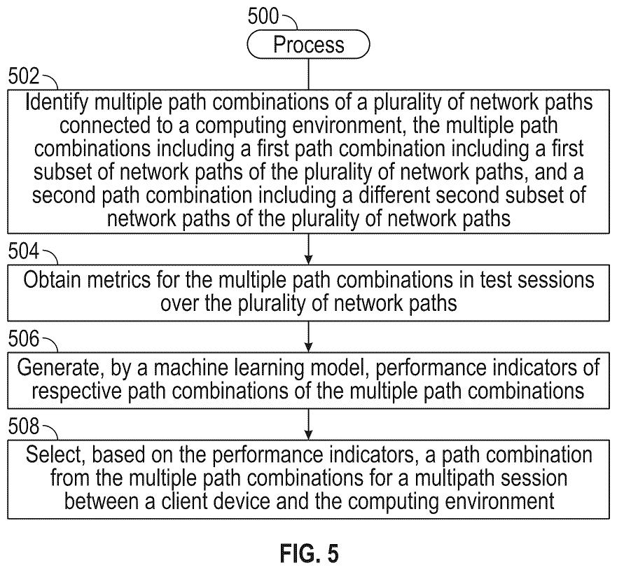

FIG. 5 is a flow diagram of a process 500 according to some examples of the present disclosure. The process 500 may be performed by the multipath connection engine 108, for example.

The process 500 includes identifying (at 502) multiple path combinations of a plurality of network paths connected to a computing environment, the multiple path combinations including a first path combination including a first subset of network paths of the plurality of network paths, and second path combination including a different second subset of network paths of the plurality of network paths.

The process 500 includes obtaining (at 504) metrics for the multiple path combinations in test sessions over the plurality of network paths. The test sessions may be multipath test sessions over candidate path combinations or individual test sessions over individual network paths.

The process 500 includes generating (at 506), by a machine learning model, performance indicators of respective path combinations of the multiple path combinations. The performance indicators may be rank indictors, cost indicators, or operational performance indicators.

The process 500 includes selecting (at 508), based on the performance indicators, a path combination from the multiple path combinations for a multipath session between a client device and the computing environment.

Examples of client devices can include any or some combination of desktop computers, notebook computers, tablet computers, smartphones, server computers, storage systems, communication nodes, household appliances, vehicles, game appliances, Internet-of-Things (IoT) devices, or other types of electronic devices.

FIGS. 2 and 5 are flow diagrams of processes including tasks performed in depicted orders. In other examples, the tasks of any of the processes may be performed in a different order, some of the tasks may be omitted, and other tasks may be added.

A storage medium (e.g., 300 in FIG. 3 or 404 in FIG. 4) can include any or some combination of the following: a semiconductor memory device such as a dynamic or static random access memory (a DRAM or SRAM), an erasable and programmable read-only memory (EPROM), an electrically erasable and programmable read-only memory (EEPROM), or a flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A non-transitory machine-readable storage medium comprising instructions that upon execution cause a system to:
receive metrics of a plurality of network paths connected to a computing environment;
determine performances of respective path combinations of the plurality of network paths based on the metrics, the path combinations comprising a first path combination including a first subset of network paths of the plurality of network paths, and second path combination including a different second subset of network paths of the plurality of network paths; and
select, based on the determined performances, a path combination from the path combinations for a multipath session between a client device and the computing environment.

2. The non-transitory machine-readable storage medium of claim 1, wherein the instructions upon execution cause the system to:
establish a plurality of multipath test sessions between the client device and the computing environment, the plurality of multipath test sessions using different subsets of network paths of the plurality of network paths, the different subsets including the first subset and the second subset; and
receive the metrics in the plurality of multipath test sessions.

3. The non-transitory machine-readable storage medium of claim 2, wherein the instructions upon execution cause the system to:
in a given multipath test session of the plurality of multipath test sessions, initiate a data download from the computing environment to test a respective subset of network paths used by the given multipath test session; and
record the metrics for the respective subset of network paths responsive to the data download in the given multipath test session.

4. The non-transitory machine-readable storage medium of claim 2, wherein the instructions upon execution cause the system to:
in a given multipath test session of the plurality of multipath test sessions, initiate bidirectional data communications between the client device and the computing environment to test a respective subset of network paths used by the given multipath test session; and
record the metrics for the respective subset of network paths responsive to the bidirectional data communications in the given multipath test session

5. The non-transitory machine-readable storage medium of claim 2, wherein the plurality of multipath test sessions comprise Multipath Transmission Control Protocol (MPTCP) test sessions.

6. The non-transitory machine-readable storage medium of claim 1, wherein the instructions upon execution cause the system to:
establish individual test sessions between the client device and the computing environment using respective individual network paths of the plurality of network paths; and
receive the metrics in the individual test sessions.

7. The non-transitory machine-readable storage medium of claim 1, wherein the plurality of network paths are between an intermediate network device and the computing environment, the intermediate network device connecting the client device to the computing environment.

8. The non-transitory machine-readable storage medium of claim 1, wherein the plurality of network paths are between the client device and the computing environment.

9. The non-transitory machine-readable storage medium of claim 1, wherein the instructions upon execution cause the system to:
select the path combination from the path combinations for the multipath session based on a policy for an entity associated with the multipath session.

10. The non-transitory machine-readable storage medium of claim 1, wherein the instructions upon execution cause the system to:
rank the respective path combinations based on the determined performances of the respective path combinations; and
select the path combination from the path combinations for the multipath session based on the ranking.

11. The non-transitory machine-readable storage medium of claim 1, wherein the instructions upon execution cause the system to:
determine the performances of the respective path combinations using a machine learning model based on the metrics.

12. The non-transitory machine-readable storage medium of claim 11, wherein the instructions upon execution cause the system to:
apply the machine learning model to the metrics for the first subset of network paths collectively to determine a performance of the first path combination.

13. The non-transitory machine-readable storage medium of claim 11, wherein the instructions upon execution cause the system to:
apply an individual instance of the machine learning model to the metrics individually for each respective network path of the first subset of network paths to determine individual performances of the network paths in the first subset of network paths; and
combine the individual performances of the network paths in the first subset of network paths to determine a performance of the first path combination.

14. The non-transitory machine-readable storage medium of claim 1, wherein the metrics of the plurality of network paths are received for a first time interval, and wherein the instructions upon execution cause the system to:
receive further metrics of the plurality of network paths for a second time interval after the first time interval;
determine updated performances of at least some of the path combinations based on the further metrics; and
update, based on the updated performances, a selection of a path combination from the path combinations for the multipath session.

15. The non-transitory machine-readable storage medium of claim 1, wherein the metrics comprise one or more of a cost metric or an operational performance metric.

16. A system comprising:
a hardware processor; and
a non-transitory storage medium storing instructions executable on the hardware processor to:
identify multiple path combinations of a plurality of network paths connected to a computing environment, the multiple path combinations comprising a first path combination including a first subset of network paths of the plurality of network paths, and second path combination including a different second subset of network paths of the plurality of network paths;
obtain metrics for the multiple path combinations;
determine performances of respective path combinations of the multiple path combinations based on the metrics;
select, based on the determined performances, a path combination from the multiple path combinations for a multipath session between a client device and the computing environment.

17. The system of claim 16, wherein the instructions are executable on the hardware processor to:
input the metrics into a machine learning model; and
determine the performances of the respective path combinations based on an output of the machine learning model.

18. The system of claim 16, wherein the instructions are executable on the hardware processor to:
establish a plurality of multipath test sessions for the multiple path combinations between the client device and the computing environment, the plurality of multipath test sessions using different subsets of network paths of the plurality of network paths, the different subsets including the first subset and the second subset; and
obtain the metrics in the plurality of multipath test sessions.

19. A method comprising:
identifying, by a system comprising a hardware processor, multiple path combinations of a plurality of network paths connected to a computing environment, the multiple path combinations comprising a first path combination including a first subset of network paths of the plurality of network paths, and second path combination including a different second subset of network paths of the plurality of network paths;
obtaining, by the system, metrics for the multiple path combinations in test sessions over the plurality of network paths;
generating, by a machine learning model in the system, performance indicators of respective path combinations of the multiple path combinations; and
selecting, by the system based on the performance indicators, a path combination from the multiple path combinations for a multipath session between a client device and the computing environment.

20. The method of claim 19, wherein the performance indicators comprise one or more of rank indicators specifying relative ranks of the multiple path combinations, cost indicators specifying costs of the multiple path combinations, or operational performance indicators of the multiple path combinations.
